(19) United States
(12) Patent Application Publication
(10) Pub. No.: US 2010/0297428 A1
(43) Pub. Date: Nov. 25, 2010

(54) COMPOSIT CONSISTING OF NANOTUBES OR NANOFIBRES ON A B-SIC FILM

(75) Inventors: Cuong Pham-Huu, Saverne (FR); Charlotte Pham, Saverne (FR); Patrick Nguyen, Strasbourg (FR); Estelle Vanhaecke, Strasbourg (FR); Svetlana Ivanova, Oberhausbergen (FR); Adrien Deneuve, Strasbourg (FR)

Correspondence Address: REMENICK PLLC, 1025 THOMAS JEFFERSON STREET, NW, WASHINGTON, DC, 20007, US

(73) Assignees: SICAT; CENTRE NATIONAL DE LA RECHERSCHE SCIENTIQUE; UNIVERSITE LOUIS PASTEUR

(21) Appl. No.: 12/598,528

(22) PCT Filed: Apr. 30, 2008
(86) PCT No.: PCT/FR08/00617

§ 371 Date: Aug. 12, 2010

(30) Foreign Application Priority Data
May 2, 2007 (FR) 0703155
Jul. 3, 2007 (FR) 0704805

(51) Int. Cl. B32B 3/26; B05D 7/00

(52) U.S. Cl. 428/319.1; 427/180; 977/742; 977/779

(57) ABSTRACT

The invention relates to a method of producing a composite comprising nanofibres or nanotubes on a porous β-SiC substrate, said method comprising the following steps: (a) a catalyst for growing nanotubes or nanofibres is incorporated into said porous β-SiC substrate or into an SiC precursor; (b) carbon nanotubes or nanofibres are grown from a mixture comprising hydrogen and at least one hydrocarbon; and (c) optionally, said carbon nanotubes or nanofibres are converted to SiC nanofibres. This composite may be used as a catalyst or catalyst support.

### TECHNICAL FIELD OF THE INVENTION

The invention relates to the technical field of nanofibers, and more specifically carbon or SiC nanofibers deposited on a substrate consisting of β-SiC foam. The composites thus formed have applications as a catalyst or a catalyst support.

### PRIOR ART

Carbon nanotubes and nanofibers have been known for a long time. These materials have beneficial catalytic properties. They are in the form of long, very fine structures, often with a napped appearance, with a very high specific volume, and are therefore difficult to handle. It is feared that they may be harmful to health, in particular by inhalation. Major precautions are now taken during their production, handling, packaging and transport. In addition, the use of catalysts or catalyst supports in the form of small free fibers or particles (such as a powder or fibers) presents the problem of head losses of the gases that are in contact with these particles or filters. And it is necessary to prevent these particles or fibers from being carried by the gas or liquid stream when they are used in catalysis.

Attaching nanotubes or nanofibers on various supports enables this problem to be avoided. For example, the article “Synthesis and characterization of carbon nanofibers with macroscopic shaping formed by catalytic decomposition of C₂H₆/H₂ over nickel catalyst” by R. Vieira et al. (Applied Catalysis A, 274 (2004), 1-8) describes the deposition of carbon nanofibers on carbon felt. The patent application FR 2 832 649 (SICAT) describes the growth of carbon nanotubes or nanofibers on various supports such as carbon felt, alumina, silica, titanium oxide, zirconium oxide or cordierite. The article “In Situ Growth of β-SiC Nanowires in Porous SiC Ceramics” by Sumin Zhu et al. (J. Am. Ceram. Soc. 88 [9], 2619-2621 (2005)) describes the growth of SiC nanofibers on a so-called “porous” α-SiC-based ceramic material (47% porosity, with an average pore size of 1.37 μm) from a polycarbosilane with a molecular weight of around 1250. The patent application JP 2004 0067393 describes the deposition of carbon nanotubes on a α-SiC-based ceramic material.

However, carbon nanotubes and nanofibers themselves have the disadvantage of being sensitive to oxidation, which in practice limits their use as a catalyst or a catalyst support.

SiC nanofibers that can be deposited, in a very small amount and simultaneously with carbon nanotubes, on a monocrystalline silicon substrate Si (001) coated with a nickel film having a thickness of several dozen nanometers are also known (see, for example, the article “Simultaneous growth of silicon carbide nanorods and carbon nanotubes by chemical vapor deposition” by B. Q. Wei et al., Chemical Physics Letters 354 (2002), pages 264-268). By depositing a thin layer of amorphous silicon on carbon nanotubes followed by annealing at 1200° C., not more than a layer of SiC is formed on the carbon nanotubes (see J. W. Lui et al., “Synthesis of SiC nanofibers by annealing carbon nanotubes covered with Si”, Chemical Physics Letters 348, pages 357-360 (2001)). The formation of SiC nanofibers has also been described in the annealing of carbon nanotubes on a silicon substrate (E. Munoz et al., “Synthesis of SiC nanorods from sheets of single-walled carbon nanotubes”, Chemical Physics Letters 359 (2002), pages 297-402). Another method for forming β-SiC nanofibers has been described in the article “Structural transformation of carbon nanotubes to silicon carbide nanorods or microcrystals by the reaction with different silicon sources in rf-induced CVD reactor” by Y. H. Mo et al. (Synthetic Metals 140 (2004), 309-315): carbon nanotubes deposited on a silicon substrate are reacted with a mixture of SiH₄+C₃H₈+H₂ or TMS (tetramethylsilane)+H₂ at a temperature of 1250° C.

In addition, the patent application US 2006/0115648 (“Nanofibers and process for making the same”) describes the production of so-called composite “SiC+C”, “SiC+TiC” or “SiC+JUN” nanofibers with a length capable of reaching several hundred meters by a process of fusion and extrusion through a small hole of the furnace at a temperature capable of reaching 1600° C. The structure of these fibers is not described.

The patent application US 2004/0202599 (“Method of producing nanometer silicon carbide material”) describes the production of SiC nanofibers from SiC powder in the presence of a catalyst (Al or Fe) at a temperature between 1300° C. and 2000° C. in an argon atmosphere. These fibers have a minimum diameter of 5 nm and a maximum length of 5 μm.

The patent application US 2005/0255033 (“Laser fabrication of continuous nanofibers”) describes the production of SiC nanofibers by a method of laser beam-induced evaporation, in the presence of a transition metal acting as a catalyst at a temperature between 500° C. and 1400° C.

The article “Synthesis and catalytic uses of carbon and silicon carbide nanostructures” by J. M. Nhut et al. (Catalysis Today 76 (2002, 11-32) describes the conversion of carbon nanofibers into SiC nanotubes under the influence of a SiO vapor generated in the reactor by reacting a mixture of Si and SiO₂. These SiC nanotubes are very fragile and cannot be handled or used for catalysis.

### Problem Addressed

This invention is intended to provide new nanotube- or nanofiber-based composites that preserve the advantages of these nanotubes or nanofibers, namely their ability to serve as a support of an active phase for catalysis, as well as their intrinsic catalytic activity, without having the known disadvantages of nanotubes or nanofibers, namely the difficulty of shaping them, dust generation, the difficulty of using them in a fixed bed reactor and their cost. This invention is also intended to provide nanotube- or nanofiber-based composites that are resistant to prolonged use at high temperatures in an oxidizing environment.

### OBJECTS OF THE INVENTION

A first object of the invention is a process for producing a composite comprising nanofibers or nanotubes on a porous β-SiC substrate in the form of granules, extruded products, monoliths or in the form of a foam, in which said process comprises the following steps:

(a) A nanotube or nanofiber growth catalyst is incorporated in said porous β-SiC substrate, or in a SiC precursor;

(b) Carbon nanotubes or nanofibers are grown from a mixture including at least one hydrocarbon and hydrogen;

(c) Optionally, said carbon nanotubes or nanofibers are converted into SiC nanofibers.

Advantageously, said porous (β-SiC substrate has a specific surface of at least 5 m²/g, and preferably at least 10 m²/g.

This process enables a composite comprising a porous SiC substrate to be prepared with carbon nanofibers or nanotubes, and/or SiC nanofibers, and preTerably a β-SiC foam substrate with a specific surface of at least 5 m²/g and preferably at least 10 m²/g, with SiC nanofibers; this composite is another object of this invention.

Yet another object of this invention is the use of this composite product as a catalyst or a catalyst support in liquid and/or gaseous phase reactions.

### DESCRIPTION OF THE FIGURES

The four figures numbered 1 to 3 relate to the process or the product according to this invention.

FIG. 1 shows the formation of CO₂, monitored by mass spectrometry, when the temperature is increased from 25° C. to 830° C. with a ramp of 15° C./min (shown in the figure by a diagonal line that refers to the temperature scale). The arbitrary units (a.u.) correspond to the intensity of the signal for a given value m/z (mass over charge)).

The curve (a) corresponds to the C nanofiber composite on SiC, prepared according to example 1.

The curve (b) corresponds to the SiC nanofiber composite on SiC, prepared according to example 4.

FIG. 2 shows the activity and selectivity of a Pd catalyst supported on a SiC nanofiber composite on (β-SiC foam for liquid phase hydrogenation of cinnamaldehyde. The y-axis shows the selectivity or the conversion efficiency in %. The x-axis shows the duration of the contact between the catalyst and the reaction medium.

Curve a): Conversion

Curve b): Hydrocinnamaldehyde yield

Curve c): Cinnamic alcohol yield

Curve d): Phenyl propanol yield.

FIG. 3 shows the head loss of composites according to the invention, measured with a gas current (air), for three foams having the same thickness. The x-axis shows the linear speed of the gas (in m/sec). The y-access shows the head loss in millibars.

Black square: (β-SiC foam+0.38% (by weight) of SiC nanofibers

Open rectangle: (β-SiC foam+23% (by weight) of SiC nanofibers.

Black triangle: (β-SiC foam.

### DEFINITIONS

In this invention, the terms “carbon nanotubes or nanofibers” and “carbon-based nanostructured composites” refer to tubes or fibers with a highly ordered atomic structure, composed of graphite hexagons, which can be synthesized under certain conditions (see the articles “Carbon nanotubes” of S. Iijima, published in the MRS Bulletin, pages 43-49 (1994)., and “Carbon nanostructures for catalytic applications” by M. J. Ledoux and C. Pham-Huu, published in Catalysis Today, 102-103, pages 2-14 (2005)). It is known that, according to the vapor deposition synthesis conditions, and in particular according to the catalysts used, it is possible to obtain either hollow tubes, optionally formed by a plurality of concentric tubes of different diameters, or solid fibers, also filiform, but containing graphite carbon in a form that is typically less ordered. Said tubes or fibers can have a diameter typically between 2 and 200 nm, this diameter being substantially uniform over the entire length of each tube or fiber.

This term is also used, mutatis mutandis, for nanofibers or nanotubes made of other materials, such as SiC.

The term “specific surface” refers to the specific “BET” surface, measured by nitrogen adsorption at liquid nitrogen temperature according to the so-called Brunauer-Emmett-Teller technique, which is well known to a person skilled in the art and described in particular in standard NF X 11-621.

### DETAILED DESCRIPTION OF THE INVENTION

The problem is solved according to the invention by growing the nanotubes or nanofibers directly on a porous β-SiC silicon carbide support, or on a silicon carbide precursor. β-SiC is known as such, and it is known that it can be used as a catalyst support or a catalyst, optionally after deposition of a zeolite layer (see the article “Beta zeolite supported on a (β-SiC foam monolith: A diffusionless catalyst for fixed-bed Friedel-Crafts reactions” by G. Wine et al., published in J. Molecular Catalysis A 258, pages 113-120 (2006)). β-SiC can be obtained by the reaction between SiO vapors with reactive carbon at a temperature between 1100° C. and 1400° C. (Ledoux process, see EP 0 313 480 B1), or by a process in which a mixture of a liquid or pasty prepolymer and a silicon powder is extruded, cross-linked, carbonized and carbidized at a temperature between 1000° C. and 1400° C. (Dubots process, see EP 0 440 569 B1 or EP 0 952 889 B1).

β-SiC foams are also known, which can be obtained by an alternative to the Dubots process, including the impregnation of a polyurethane foam with a suspension of a silicon powder in an organic resin (Prin process, see EP 0 624 560 B1, EP 0 836 882 B1 or EP 1 007 207 A1).

All of these β-SiC supports can be used in this invention. Advantageously, β-SiC monoliths, extruded products, granules or foams are used. The specific surface of the support, determined by the BET method, which is well known to a person skilled in the art, is preferably greater than 5 m²/g and more preferably greater than 10 m²/g. The β-SiC foam, prepared according to the Prin process mentioned above or by any other process, with a specific surface greater than 5 m²/g and advantageously greater than 10 m²/g, is an especially preferred support for the production of this invention.

The process according to the invention, enabling carbon nanotubes or nanofibers; or SiC nanotubes or nanofibers, to be grown on a porous β-SiC support, involves the following steps:

Step (a): Incorporation of a nanotube or nanofiber growth catalyst in the porous β-SiC support.

This catalyst is intended to catalyze the growth of carbon nanotubes or nanofibers. Advantageously, nickel is used, in particular to produce carbon nanofibers, or iron, cobalt or a mixture of iron and cobalt in order to produce carbon nanotubes. Any other binary or ternary mixture of these three elements can also be used.

We will now describe a typical embodiment for this step. The porous β-SiC support is impregnated with a solution of an active phase precursor. An aqueous or alcoholic solution is suitable. The precursor can be a salt of a transition metal, for example Ni(NO₃)₂. The metal content (metal load) is advantageously between 0.4% and 3% by weight, and preferably between 0.5% and 2%. After impregnation, it is dried in the oven, preferably at a temperature between 80° C. and 120° C. for 1 to 10 hours, then calcined in air or in an inert atmosphere at a temperature between 250° C. and 500° C. The active phase precursor is then converted into an active phase, preferably by reduction in a reducing gas at a suitable temperature, for example between 250° C. and 500° C. in hydrogen. The duration of this reduction is typically between 0.2 and 3 hours.

Step (b): Growth of carbon nanotubes or nanofibers from a mixture including at least one hydrocarbon and hydrogen.

The hydrocarbon is a C1 to C10 aliphatic, olefinic, acetylenic or aromatic hydrocarbon. The aliphatic, olefinic or acetylenic hydrocarbons can be linear or branched. C1 to C4, and in particular C2 or C3 aliphatic or olefinic hydrocarbons are preferable. Acetylene is also suitable. Among the aromatic hydrocarbons that can be used are toluene, which, mixed with ferrocene, leads, according to the observations of the present inventors, to the formation of carbon nanotubes aligned on a SiC substrate.

It is known from the article “Evidence of Sequential Lift in Growth of Aligned Multiwalled Carbon Nanotube Multilayers”, by M. Pinault et al., Nano Letters Vol. 5, No. 12, pages 2394-2398 (2005)) that the CVD (Chemical Vapor Deposition) technique using aerosols containing a mixture of benzene or toluene and ferrocene leads, on a silicon substrate, to the formation of aligned carbon nanotubes with multiple walls.

In this invention, a gaseous mixture including at least one hydrocarbon and hydrogen is used. The temperature of the reaction must be between 300° C. and 1000° C., and is preferably between 600° C. and 800° C. Thus, carbon nanofibers or nanotubes are obtained. To obtain SiC nanofibers, a third step is necessary:

Step (c): Conversion of carbon nanotubes or nanofibers into SiC nanotubes and nanofibers.

In this optional step, carbon nanotubes or nanofibers are reacted with a SiO vapor in a heat treatment chamber. The SiO vapor can be produced in the heat treatment chamber, as close as possible to the carbon structures to be converted into SiC. In one embodiment, the generation of SiO can be ensured by heating a mixture of Si and SiO₂ placed in the vicinity of the carbon nanotubes or nanofibers. In another embodiment, the carbon nanotubes or nanofibers can be embedded in a SiC precursor matrix (this term is explained below) containing, for example, a mixture of Si and phenolic resin.

To obtain β-SiC, the reaction temperature is advantageously between 1000° C. and 1500° C., preferably between 1050° C. and 1400° C. and even more preferably between 1150° C. and 1350° C.

According to the duration of the reaction, a partial or complete conversion of the carbon nanotubes or nanofibers into SiC nanofibers, and in particular β-SiC, can be obtained.

Thus, steps (a) and (b), optionally followed by a step (c), lead to a new composite product comprising a porous (β-SiC substrate with carbon nanotubes or nanofibers and/or SiC. These nanotubes or nanofibers can be aligned, by using, as the hydrocarbon in step (b), a mixture formed (i) by at least one aromatic hydrocarbon, preferably toluene, and (ii) ferrocene.

A particularly preferred product is a composite consisting of:

(i) a (β-SiC foam with a specific surface of at least 10 m²/g and

(ii) comprising carbon nanofibers or nanotubes, and/or SiC nanofibers.

This new composite product can be used as a catalyst or a catalyst support.

Below, an alternative of the process according to the invention is described. According to this process, the nanotubes or nanofibers are deposited not on a porous SiC substrate, but on a precursor of such a porous SiC substrate, referred to here as a “SiC precursor”. In this alternative, carbon nanotubes or nanofibers are grown on a porous substrate containing carbon and silicon; this substrate is, for example, in the form of an extruded product or a foam. Then, this substrate and the nanotubes or nanofibers are converted into SiC, and in particular (β-SiC.

In a typical embodiment of this alternative, step (a) includes the preparation of a precursor of a porous SiC substrate by infiltration of a carbonizable polymer foam with a liquid mixture including a thermosetting resin and silicon powder, followed by drying of the infiltrated foam, followed by polymerization of the resin, and followed by carbonization of the resin and the foam.

The thermosetting resin can be pure or diluted in a suitable solvent, such as ethanol, acetone or another suitable organic solvent. This enables its viscosity to be adjusted, thereby promoting the mixing thereof with the silicon powder and the infiltration thereof into the polymer foam. As a thermosetting resin, it is possible, to use, for example, phenolic or furfurylic resins.

As a polymer foam, a polyurethane cell foam is advantageously used. This foam can, for example, have an open macroscopic structure of which the average diameter is between around 600 μm and 4500 μm.

After infiltration, the foam can be dried in ambient air. The polymerization temperature is typically between 130° C. and 200° C., and the carbonization temperature is between 500° C. and 900° C. A temperature of around 800° C. is particularly advantageous. It is preferred to perform this treatment in an argon atmosphere. Thus, a carbon foam is obtained, which has a carbon skeleton containing silicon inclusions, and which forms the SiC precursor. This carbon foam advantageously has a specific BET surface of between 80 m²/g and 250 m²/g, and more advantageously between 100 m²/g and 200 m²/g. This very large specific surface is advantageous because it enables good dispersion of the nanotube or nanofiber growth catalyst on the SiC precursor; owing to this very good dispersion, the surface density of nanotubes and nanofibers formed, and therefore the efficiency during synthesis thereof, is very high.

Alternatively, but less preferably, it is possible to use extruded carbon products, typically comprised of sub-micronic carbon grains and containing silicon inclusions; these extruded products can be prepared by carbonizing a mixture of carbonizable resin and silicon powder. Their specific BET surface is typically between 20 m²/g and 70 m²/g.

The incorporation in this SiC precursor of a nanotube or nanofiber growth catalyst can be done by impregnation with an aqueous solution (possibly mixed with an alcohol, such as ethanol) of a salt of nickel, iron, cobalt, or a binary or ternary mixture of these three elements; this salt is an active phase precursor. As an example, it is possible to deposit a nickel salt, typically Ni(NO₃)₂. A metal content of between 0.1% and 10%, and preferably between 0.2% and 5% (weight percent) is advantageous. The active phase precursor is dried, calcined and converted into an active phase, as described above.

On this material, in step (b), as described above, carbon nanotubes or nanofibers are grown. To obtain a composite material comprising SiC nanotubes or nanofibers on a (β-SiC substrate, in step (c), both the carbon nanotubes or nanofibers and the SiC precursor are converted into (β-SiC, by a heat treatment at a temperature between 1200° C. and 1500° C., and preferably between 1300° C. and 1900° C. A temperature of around 1350° C. for a period of between 0.5 and 5 hours, and typically one hour, is suitable. It is preferable to work in argon. Under these process conditions, the silicon powder reacts with the carbon of the carbon skeleton; this reaction probably involves SiO vapors generated in situ, which diffuse the core of the carbon foam outwardly. The oxygen of the SiC comes in particular from the passivation layers of the silicon (oxide layer) as well as from the resin. It is also possible to additionally use an extrinsic SiO source, as described above. It is also possible to add, as described above, SiC precursor. If the amount of silicon available is insufficient, or if the conditions are chosen so as not to enable the formation of a sufficient amount of SiO, the carbon nanotubes or nanofibers will not be converted, or will be only partially converted, into SiC.

This alternative of the process is particularly advantageous if it is desirable to obtain a SiC nanofiber composite on a (β-SiC substrate, because it involves only two high-temperature treatment steps, whereas the process using a (β-SiC substrate involves three high-temperature treatment steps, counting the step leading to the formation of the starting (β-SiC.

This alternative of the process also has the advantage of deactivating the active phase particles (for example nickel) used as a carbon nanofiber or nanotube growth catalyst, because said particles are carbidized or silicidized under the conditions of step (c). These deactivated particles will not interfere with the subsequent use of the composite as a catalyst or a catalyst support.

### ADVANTAGES AND USE OF THE INVENTION

The invention has numerous advantages. The growth of nanotubes or nanofibers can largely fill the pores, and in particular the macropores, of the support, and in particular in the case of (β-SiC foams. It is noted that the head loss of a gaseous or liquid stream caused by the presence of nanotubes or nanofibers is very low. Moreover, the nanotubes or nanofibers do not easily become detached from their support, as noted, for example, in a sonication test. They also show good intrinsic stability, which makes them suitable for use in catalysis.

Moreover, the composite product according to the invention has a large specific surface. With carbon nanotubes or nanofibers, a very large specific surface is obtained, which is advantageously greater than 60 m²/g, and even more advantageously greater than 100 m²/g, knowing that it can reach 200 m²/g. Composites with a specific surface between 60 m²/g and 200 m²/g are preferred, and more specifically those with a specific surface between 100 m²/g and 160 m²/g.

With SiC nanofibers, a slightly smaller specific surface is obtained: it is advantageously greater than 20 m²/g, and even more advantageously greater than 30 m²/g. Such products according to the invention typically have a specific surface between 20 m²/g and 80 m²/g, with a preference for products having a specific surface between 30 m²/g and 50 m²/g.

This specific surface is very easily accessible to the gaseous phase when it is used as a catalyst or a catalyst support in chemical reactions in the gaseous phase, without this access being limited by the diffusion through a thick porous material. This is favorable to good control of the selectivity of the catalyzed reactions. Indeed, the large surface of these composite products according to the invention consists, on the one hand, of a non-porous surface (external geometric surface of the nanotubes), and, on the other hand, of mesoporous and macroporous surface over a thickness not exceeding several dozen microns (porous surface of the SiC cell foam).

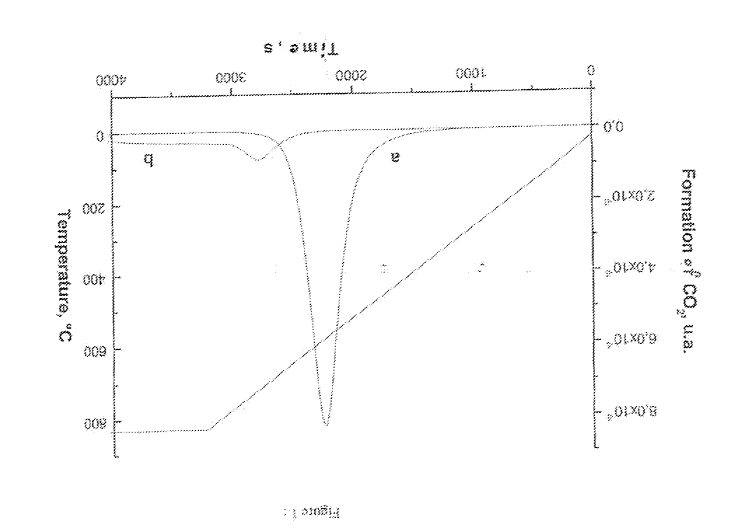

In addition, the composite product according to the invention formed by SiC nanotubes or nanofibers on a SiC support has improved stability in an oxidizing environment with respect to a material formed by carbon nanotubes or nanofibers on a SiC support. This is shown in FIG. 1, which shows thermogravimetric analysis curves (TGA). This new catalyst support can be used in an oxidizing environment, and more specifically with an oxidizing gaseous phase, for example in air, at a temperature above 500° C., and even at a temperature above 800° C. or even 900° C. in air, with an industrially acceptable lifetime. In spite of a slightly smaller specific surface than that of the composites according to the invention with carbon nanotubes or nanofibers, this composite according to the invention with SiC nanofibers is therefore particularly beneficial for the chemical industry.

The composite product according to the invention can be used as a catalyst support, after the deposition of a suitable active phase. As an example, it is possible to deposit, by known methods, palladium particles on the support. It is possible to catalyze chemical reactions in the gaseous phase and/or in the liquid phase, such as aldehyde hydrogenation reactions. The hydrogenation of cinnamaldehyde in the liquid phase is an example of a reaction that can be catalyzed by the composite product according to the invention, after deposition of a suitable active phase. The catalyst is very stable.

The composite product according to the invention can also be used directly as a catalyst.

With regard to a monolithic SiC foam piece, the separation of the catalyst and reaction products presents no problem.

The following examples show embodiments of the invention, but do not limit the scope thereof.

### EXAMPLES

### Example 1

### Preparation of a “Carbon Nanofiber on β-SiC Foam” Product According to the Invention

A (β-SiC foam with an average macropore size of around 1700 μm and a specific surface of 10 m²/g, prepared according to known techniques, was impregnated with an aqueous solution of Ni(NO₃)₂ so as to obtain a nickel load of 1% by weight in the β-SiC foam. The impregnated foam was dried for 2 hours at 100° C. in an oven, and then calcined in air at 400° C. A reduction by hydrogen was performed at this in situ temperature. Then, the hydrogen was replaced by a mixture of C₂H₆/H₂ (flow rate: 60 ml min⁻¹/40 ml min⁻¹) and the reaction temperature was increased from 400° C. to 750° C. with a heating rate of 20° C. min⁻¹. The carbon nanofiber synthesis was performed for 2 hours under these conditions, and the reactor was then left to cool to room temperature, while maintaining the C₂H₆/H₂ gas stream.

The composite “carbon nanofiber on β-SiC foam” product thus obtained contained 28% by weight carbon nanofibers, and had the same appearance and morphology and the same mechanical behavior as the starting foam, except that the gray-green color of the initial 1β-SiC had changed to black. The microscopic observation of the morphology by scanning electron microscopy (SEM, using a Jeol™ microscope of the JSM-6700F type equipped with a CCD camera, with an accelerating voltage of 3 kV on surfaces coated with a gold film) shows that all of the cavities of the initial (β-SiC foam were filled by a dense and entangled array of carbon nanofibers.

The specific surface of this composite product was 52 m²/g, while the starting β-SiC foam had a specific surface of only around 10 m²/g. The specific surface of the carbon nanofibers is estimated at approximately 140 m²/g. The transmission electron microscopy (TEM), using a Topcon™ microscope of the 002B type with an accelerating voltage of 200 kV and a point-to-point resolution of 0.17 nm, on samples ground then dispersed in ethanol under ultrasonic agitation, of which one drop was then deposited on a copper grid coated with carbon) shows the quasi-absence of carbon nanoparticles: only carbon nanofibers are seen, which form a homogeneous layer and represent an entangled array of fibers with a substantially constant diameter on the order of 40 nm and a length capable of reaching several dozen micrometers, which are connected to one another by bridges. These bridges are probably the cause of the high mechanical resistance of this entanglement of nanofibers, which is a property conducive to their use in catalysis, in which it is desirable to have a catalyst with good mechanical stability under a gas or liquid stream. The absence of pores in the nanofibers is also noted; this makes them beneficial as a catalyst or a catalyst support, in particular in a liquid environment in which diffusion phenomena become predominant.

The product has good stability in an oxidizing environment up to a temperature on the order of 600° C., at which the carbon nanofibers being to become oxidized into CO₂, as shown by the curve (a) of FIG. 1.

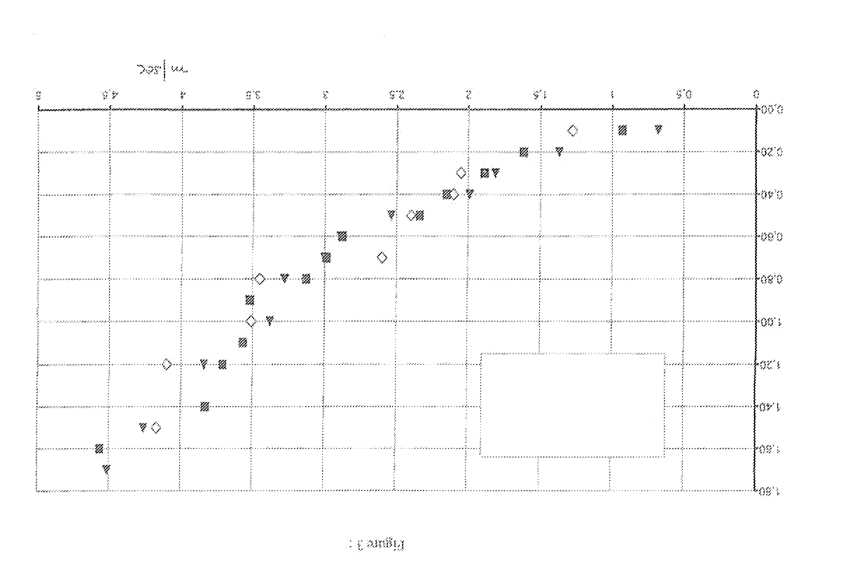

The head loss was measured in the composite according to the invention. The results are indicated in FIG. 3. This head loss is very low, whereas a greater head loss can be expected when the macropores of the substrate (β-SiC foam) are filled with a nanoscopic material. It is also noted that the macroporosity of the initial D-SiC foam diminishes only very little during the growth of carbon nanofibers: from 0.9 (i.e. 90% of the apparent empty volume) to 0.85 for a carbon nanofiber content of 20% by weight.

The anchoring of the nanofibers on their β-SiC foam support was determined by a sonication test for 30 minutes. No loss of nanofibers was observed during this test.

### Example 2

### Preparation of a “Sic Nanofiber on β-SiC Foam” Product According to the Invention

In an alternative of the process described in example 1, instead of allowing the reactor to cool to room temperature, the temperature was increased to 1200° C. At this temperature, the in situ generation of SiO vapor enables the carbon nanofibers to be converted into SiC nanofibers. The temperature of 1200° C. was maintained for hours. As this reaction was accompanied by the formation of CO and CO₂, these gases were constantly removed by pumping. The product obtained has a specific BET surface of around 25 m²/g.

The reaction temperature of 1200° C. is not sufficient to cause the β-SiC foam to be converted into α-SiC, a conversion that would lead to a very significant loss of specific surface. It was actually found that the specific surface of an α-SiC formed at a suitable, higher, temperature is on the order of 0.1 m²/g to 1 m²/g.

The microscopic observation of this composite was performed under conditions similar to those described in example 1. It was noted that the SiC nanofibers were formed by a stack of SiC nanoparticles along the axis of the nanofiber, with these nanoparticles having a size on the order of 30 nm to 60 nm, and the diameter of the SiC nanofibers being slightly larger than that of the carbon nanofibers from which they originate.

### Example 3

### Use of a Product According to the Invention to Catalyze a Chemical Reaction in the Liquid Phase

Hydrogenation of the cinnamaldehyde in the liquid phase was performed in a glass autoclave reactor with an effective volume of 1000 ml equipped with a mechanical agitator. The reaction solution contained 500 ml of dioxane and 10 ml of cinnamaldehyde. The dioxane was used instead of an alcohol in order to prevent a homogeneous reaction capable of producing heavy and undesirable by-products. The foam catalyst (diameter 30 mm, thickness 15 mm) was attached to a glass rod and used as an agitator. To remove any trace of oxygen from the solution, the argon (flow rate of 50 ml min⁻¹) was bubbled at room temperature through this liquid phase, while agitating vigorously (around 500 rpm⁻¹). Then, the temperature was increased to 80° C. with a heating rate of around 10° C. and the argon stream was replaced by a hydrogen stream at the same flow rate. The cinnamaldehyde concentration and the distribution of the various products were monitored throughout the reaction as a function of time by gas chromatography using a Varian™ 3800 chromatograph equipped with a Pona capillary column coated with methyl siloxane and a flame ionization detector (FID), which analyzed microsamples periodically obtained and diluted in dioxane. The chromatograms were calibrated using known concentrations of pure cinnamaldehyde, cinnamic alcohol, 3-phenyl propanol and 3-phenylpropenal substances.

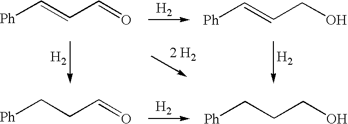

This complex reaction involves hydrogenation of C═C and C═O bonds and passes through a plurality of intermediate products, in particular cinnamic alcohol (upper right-hand portion of the reaction diagram) and hydrocinnamaldehyde (lower left-hand portion of the reaction diagram), which can then be converted into 3-phenyl-1-propanol (lower right-hand portion of the reaction diagram).

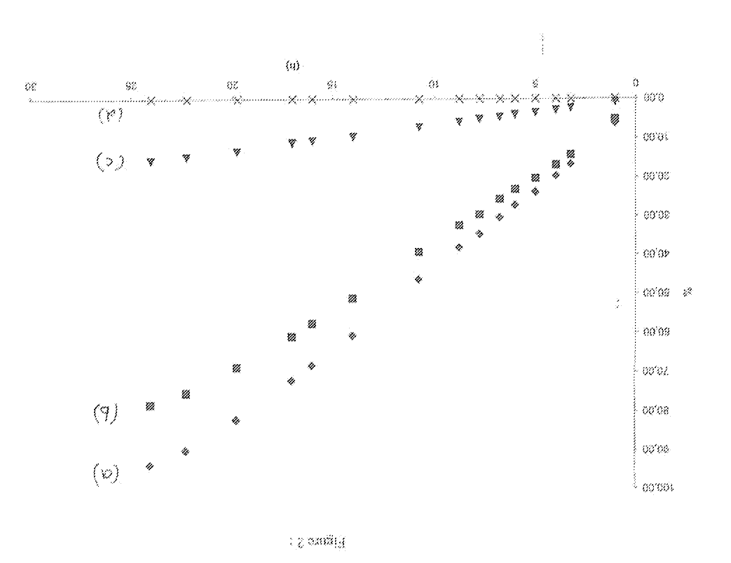

After 24 hours of contact between the catalyst and the reaction medium, a cinnamaldehyde conversion rate of at least 90%, and a hydrocinnamaldehyde yield of at least 75% are obtained; the cinnamic alcohol yield does not exceed 15%. Typical results of these tests are shown in FIG. 2.

### Example 4

### Preparation of a Composite Product of Sic Nanofibers on (β-SiC Foam According to the Invention

A polyurethane cell foam was infiltrated with a liquid mixture including a phenolic resin (diluted in ethanol to adjust its viscosity) and silicon powder. After drying, polymerization at around 160° C. and carbonization at a temperature of around 800° C. in argon were performed. A carbon skeleton containing silicon powder inclusions was thus obtained. It was impregnated with an aqueous solution of Ni(NO₃)₂ so as to obtain a 1% (by weight) nickel load. This material was then treated according to example 1 to obtain carbon nanofibers on the carbon precursor. The composite material thus obtained was placed at 1360° C. in 1 bar of argon for 1 h to convert the carbon skeleton and the carbon nanofibers into (β-SiC, by a reaction with the silicon present in situ.

The product obtained after carbidation has a “blue” color characteristic of (β-SiC. This material was sonicated for 30 minutes, and no loss of mass was observed, thus proving the successful anchoring of the nanostructures on their support.

The product has a specific BET surface of 55 m²/g and good stability in an oxidizing environment up to a temperature above 730° C. The curve (b) in FIG. 1 shows a first oxidation peak attributed to the residual carbon from the carbon nanofibers, followed by a shoulder at a higher temperature attributed to the beginning of oxidation of the SiC nanofibers.

### Example 5

Carbon Nanotubes or Nanofibers were Deposited on a Porous (β-SiC Support, According to Two Different Embodiments of this Invention.

(i) Extruded carbon products with an average size of 1 mm were prepared as a SiC precursor by pyrolysis of a resin—silicon powder mixture for 3 hours at 750° C. in argon. The extruded carbon product thus obtained had a specific BET surface of 34.9 m²/g. A nickel salt solution corresponding to a 1% nickel load was deposited on these extruded products. Carbon nanotubes or nanofibers were grown on this substrate, stopping the growth reaction after three different durations, corresponding to 24%, 50% and 73% by weight of carbon nanotubes or nanofibers. The total BET surface was then determined. It was respectively 71.8 m²/g, 98.9 m²/g and 148 m²/g.

(ii) On β-SiC grains, obtained by grinding extruded products, and of which the diameter was between 125 μm and 250 μm, and of which the specific BET surface was 30.7 m²/g, a nickel salt solution corresponding to a 1% nickel load was deposited. Carbon nanotubes or nanofibers were grown on this substrate, stopping the growth reaction after two different durations, corresponding to 10% and 19% by weight of carbon nanotubes or nanofibers. The total BET surface was then determined. It was respectively 80.4 m²/g and 101 m²/g.

1. Process for producing a composite comprising nanofibers or nanotubes on a porous (β-SiC substrate in the form of granules, extruded products, monoliths or in the form of a foam, said process comprising the following steps:
(a) A nanotube or nanofiber growth catalyst is incorporated in said porous (β-SiC substrate, or in a (β-SiC precursor;
(b) Carbon nanotubes or nanofibers are grown from a mixture including at least one hydrocarbon and hydrogen;
(c) Optionally, said carbon nanotubes or nanofibers are converted into SiC nanofibers.

2. Process according to claim 1, in which said (β-SiC precursor is a carbon foam comprising silicon inclusions.

3. Process according to claim 1, in which said porous (3 —SiC substrate has a specific surface of at least 5 m²/g, and preferably at least 10 m²/g.

4. Process according to any one of claims 1 to 3, in which said growth catalyst is selected from the group consisting of nickel, iron, cobalt, binary mixtures of these three elements or ternary mixtures of these three elements.

5. Process according to any one of claims 1 to 4, in which said hydrocarbon used in step (b) is selected from linear or branched C1 to C10 aliphatic, olefinic or acetylenic hydrocarbons, or from aromatic hydrocarbons.

6. Process according to claim 5, in which said hydrocarbon is selected from the C1 to C4 aliphatic or olefinic hydrocarbons, and preferably among those at C2 or C3.

7. Process according to claim 5, in which said hydrocarbon is acetylene or an aromatic hydrocarbon/ferrocene mixture.

8. Process according to any one of claims 1 to 7, in which, in step (c), the carbon nanotubes or nanofibers are reacted with a SiO vapor, at a temperature between 1000° C. and 1500° C., preferably between 1050° C. and 1400° C.

9. Composite comprising a porous β-SiC substrate in the form of granules, extruded products, monoliths or foam, and having a specific surface of at least 5 m²/g, and preferably at least 10 m²/g, with carbon nanotubes or nanofibers, and/or SiC nanofibers or nanotubes.

10. Composite according to claim 9 with carbon nanotubes or nanofibers, characterized in that it has a specific surface greater than 60 m²/g, preferably greater than 100 m²/g and even more preferably between 100 m²/g and 160 m²/g.

11. Composite according to claim 9 with SiC nanofibers, characterized in that it has a specific surface greater than 20 m²/g, preferably greater than 30 m²/9 and even more preferably between 20 m²/g and 80 m²/g.

12. Use of a composite product according to any one of claims 9 to 11 as a catalyst or catalyst support in liquid and/or gaseous phase reactions.

13. Use according to claim 12 in aldehyde hydrogenation reactions, and preferably in hydrogenation of cinnamaldehyde in the liquid phase.

14. Use according to claim 12 or 13 of a composite according to claim 10 in gaseous phase reactions in an oxidizing atmosphere at a temperature above 50.0° C.

15. Use according to claim 14 in air at a temperature above 800° C.
